(19) United States
(12) Patent Application Publication
(10) Pub. No.: US 2014/0365861 A1
(43) Pub. Date: Dec. 11, 2014

(54) PREFETCHING BINARY DATA FOR USE BY A BROWSER PLUGIN

(71) Applicants: Vermont Lasmarias, Fremont, CA (US); Christopher S. Co, San Jose, CA (US); Mihai Mudure, Santa Clara, CA (US)

(72) Inventors: Vermont Lasmarias, Fremont, CA (US); Christopher S. Co, San Jose, CA (US); Mihai Mudure, Santa Clara, CA (US)

(73) Assignee: GOOGLE INC., Mountain View, CA (US)

(21) Appl. No.: 13/093,643

(22) Filed: Apr. 25, 2011

(51) Int. Cl. G06F 17/00

(52) U.S. Cl. 715/234

(57) ABSTRACT

A web page having content and instructions is stored on a tangible non-transitory computer-readable medium. A browser application executes on a processor of a client device. When the browser application interprets the instructions in the web page, the instructions cause the browser application to display the content on the client device, transfer binary data to a system cache of the client device prior to the functionality of a browser plugin being invoked, where the binary data is used only by the browser plugin configured to operate in the browser application, and invoke functionality of the browser plugin, so that the browser plugin accesses the binary data via the system cache during execution.

### FIELD OF THE DISCLOSURE

This disclosure relates to executing software tasks in a computing environment and, in particular, to reducing start-up latency of software tasks.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In a typical computing environment, one or several processors operate on instructions and data, collectively referred to herein as “binary data,” loaded into a quickly-accessible physical memory that has a high read speed and a high bandwidth. The quickly-accessible physical memory operates as active storage during execution of software tasks, and binary data usually is loaded into the quickly-accessible physical memory from a slower-accessible physical memory that has a lower read speed and/or a lower bandwidth. In some computing environments, physical memory is organized into multiple layers or stages according to access speed, bandwidth, and other characteristics. For example, a personal computer usually includes a central processing unit (CPU) equipped with on-chip cache, a motherboard on which the CPU resides along with a second-level cache, a memory chip that provides additional volatile memory, and a high-volume persistent storage device such as a hard disk, a flash-based storage, a compact disk (CD), etc. In general, physical memory in a computing environment includes an active storage and at least one type of secondary storage.

It is also typical for binary data to be divided into blocks or “pages” of a certain size and mapped to a virtual address space, in which some of the addresses correspond to pages loaded into an active storage, while other addresses correspond to pages in a secondary storage, possibly on a hard disk or another type of a persistent storage device. As is known, virtual memory allows software tasks to allocate and reference contiguous blocks of memory even when contiguous blocks of memory of the requested size are not available in the active storage. A memory management unit (MMU) or a similar hardware or software component manages the virtual address space and provides address resolution.

During execution, a software task may often request pages using virtual memory addresses. When the referenced page is unavailable in the active storage, the MMU detects a so-called “page fault” condition and requests that the page be transferred to the active storage from the corresponding secondary storage device, e.g., the hard disk. Because the secondary storage device generally cannot provide the same access speed and bandwidth as the active storage, page faults significantly slow down the execution of the software task.

### SUMMARY

According to an embodiment, a web page having content and instructions is stored on a tangible non-transitory computer-readable medium. A browser application executes on a processor of a client device. When the browser application interprets the instructions in the web page, the instructions cause the browser application to display the content on the client device, transfer binary data to a system cache of the client device, where the binary data is used only by a browser plugin configured to operate in the browser application, and where the binary data is transferred to the system cache prior to the functionality of the browser plugin being invoked, and invoke functionality of the browser plugin, so that the browser plugin accesses the binary data via the system cache during execution.

According to another embodiment, instructions are stored on a tangible non-transitory computer-readable medium. When executed by a processor, the instructions cause the processor to receive an indication that a browser plugin is to be activated within a browser application, where the browser application executes on the processor. In response to receiving the indication, the instructions cause the processor to identify binary data which the browser plugin uses during execution and prefetch the binary data before the browser plugin is activated, so that the binary data is available in a system cache when the browser plugin is activated.

According to another embodiment, a method for efficiently activating a browser plugin is implemented in a browser application that executes on a processor and operates on a web page having content and a plurality of instructions. The method includes receiving an indication that the browser plugin is to be activated, in response to receiving the indication, identifying binary data which the browser plugin uses during execution, and prefetching the binary data before the browser plugin is activated, so that the binary data is available in a system cache when the browser plugin is activated.

### BRIEF DESCRIPTION OF THE DRAWINGS

FIG. 1 is a block diagram of an example computing environment in which a prefetching application transfers (or “prefetches”) binary data for use by a software application to a system cache prior to the software application being launched;

FIG. 2 is a block diagram of an example computing environment in which a prefetching software component prefetches binary data for a browser plugin prior to the browser plugin being activated within a browser application;

FIG. 3 is a message sequence diagram that illustrates an example message exchange between components in a computing environment to prefetch of binary data prior to launching a software component that utilizes the binary data, according to an embodiment;

FIG. 4 is a message sequence diagram that illustrates an example message exchange between components in a computing environment to implement a pipelined prefetch of binary data prior to launching a software component that utilizes the binary data, according to an embodiment;

FIG. 5 is a message sequence diagram that illustrates an example message exchange between components in a computing environment to implement a prefetch of binary data from a local persistent storage device as well as a remote host prior to launching a software component that utilizes the binary data, according to an embodiment;

FIG. 6 is a flow diagram of an example method for prefetching binary data for use by a software application prior to launching the software application, according to an embodiment;

FIG. 7 is a flow diagram of an example method for prefetching data for a software application following an installation of the software application in a computing environment, according to an embodiment;

FIG. 8 is a flow diagram of an example method for pipelined prefetching of binary data for a software task using a prefetching task that executes concurrently with the software task, according to an embodiment;

FIG. 9 is a flow diagram of an example method for processing a web page in which a prefetching component prefetches binary data for a browser plugin prior to the functionality of the browser plugin being invoked, according to an embodiment;

FIG. 10 is a flow diagram of an example method for efficiently prefetching binary data corresponding to one or several files, according to an embodiment;

FIG. 11 is a diagram of an example Hypertext Markup Language (HTML) web page in which a call to prefetching application programming interface (API) prior to invoking the functionality of a browser plugin causes binary data used by the browser plugin to be prefetched; and

FIG. 12 is a diagram of an example HTML web page in which an invisible or “hidden” section of the web page is automatically created for use by a prefetching script that prefetches binary data for a browser plugin prior to the functionality of the browser plugin being invoked.

### DETAILED DESCRIPTION

In the embodiments discussed below, a software component, such as an application that executes in a computing environment independently from other applications (i.e., an “executable”) or a plugin component that extends the functionality of another software application operating in the computing environment, executes with a reduced start-up latency to thereby increase system efficiency as well as improve overall user experience. To this end, a prefetching software component causes at least some of the binary data used by the software component during execution, which may include the software component itself, to be transferred to an active storage prior to the software component starting execution. As a result, the software component encounters fewer page faults and accordingly executes faster during the start-up stage and, in some cases, during the subsequent stages of operation. The process of prefetching binary data into an active storage may be referred to as “prewarming” a software component. Depending on the embodiment, the prefetching software component is invoked automatically in response to a user command to launch the software component, or conditionally in response to an appropriate application programming interface (API) call. Further, depending on the embodiment and/or configuration, the prefetching component transfers binary data to the active storage only once (e.g., prior to the software component being launched) or periodically in a pipelined manner (e.g., prior to and during the execution of the software component).

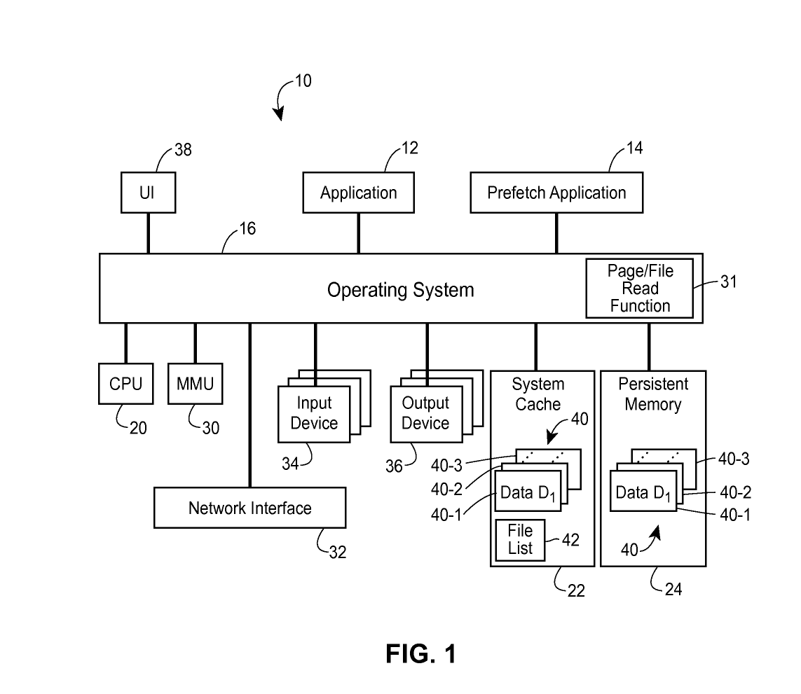

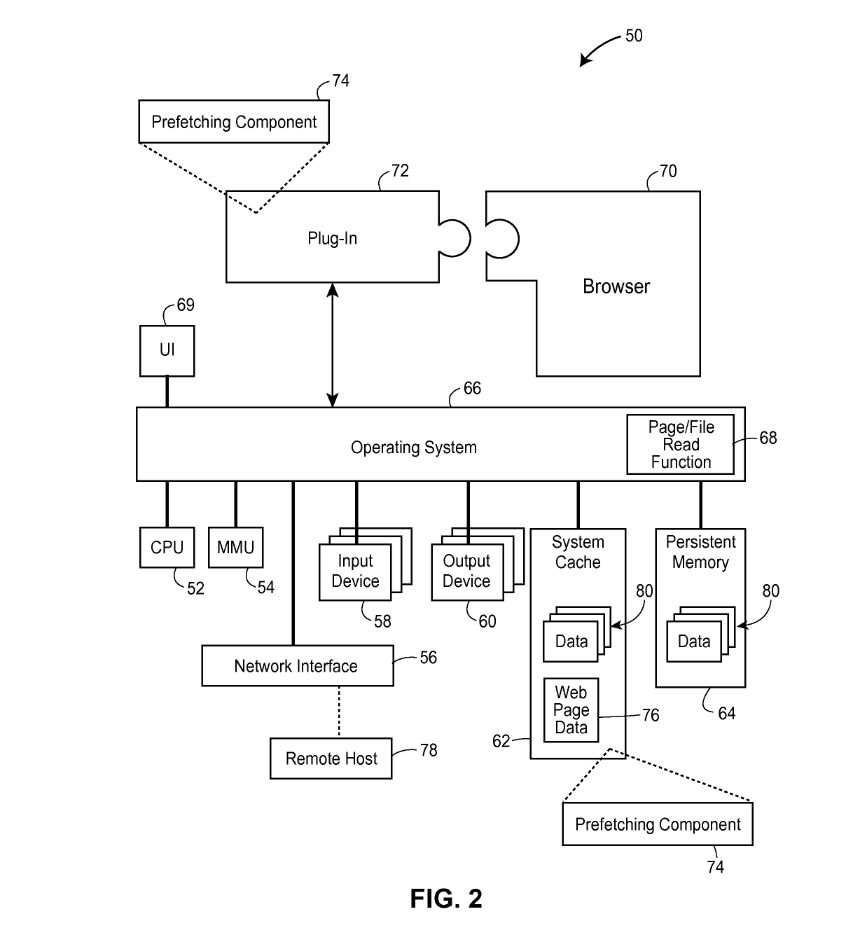

With reference to FIGS. 1-12, several examples of the techniques of the present disclosure will now be described. As an initial matter, FIGS. 1 and 2 illustrate examples of a computing environments in which a prefetching component, which also may be referred to herein as a software task, prefetches binary data for an application and a plugin, respectively. In general, the computing environment of FIG. 1 or FIG. 2 may be implemented in a stationary personal computer (PC), a portable PC (e.g., a laptop, a tablet PC), a mobile device (e.g., a smartphone), etc. Further, in some embodiments, the components illustrated in FIGS. 1 and 2 may be distributed among two or more computing devices.

Referring first to FIG. 1, an example computing environment 10 includes a software application (or simply “application”) 12 and a prefetching application 14 operating in an operating system (OS) 16 such as Windows, Mac OS, Linux, Android, etc. For simplicity, the term “software application” is used herein to refer both to an instance of a software application executing in the computing environment 10 and to the set of computer instructions that defines the software application. However, it will be understood that while an instance of an application executes in the computing environment 10, machine-readable instructions of the application are stored on a non-transitory, computer-readable medium such as the persistent memory 24, the system cache 22, or both. The OS 16 executes on a central processing unit (CPU) 20 that includes one or several CPU cores, depending on the embodiment. The computing environment 10 also includes a system cache 22 that may be implemented as a quickly-accessible physical memory such as random access memory (RAM). In general, the system cache 22 may be provided on a same chip as the CPU 20 or on a separate chip. In some embodiments, the system cache 22 is a dedicated memory region on a RAM chip. During operation, the system cache 22 operates as an active storage, so that software tasks such as the application 12 access memory pages (or simply “pages”) stored in the system cache 22 quickly and efficiently.

The computing environment 10 further includes a persistent memory 24 that may be a hard disk, a flash drive, a CD, a DVD, a tape drive, etc. In at least some of the embodiments, the persistent memory 24 is significantly slower that the system cache 22. In particular, the persistent memory 24 may have one or more of a slower read speed, a slower write speed, a lower bandwidth (i.e., the size of a data block the persistent memory 24 can supply to the CPU 20 at one time), etc. According to an embodiment, a memory management unit (MMU) 30 manages a virtual memory that includes at least a portion of the system cache 22 and at least a portion of the persistent memory 24 mapped to a common virtual address space. When a software task such as the software application 12 requests that a block of memory be allocated for use by the application 12, the MMU 30 may allocate the requested memory block in the virtual memory, with some of the pages residing outside the system cache 22. Although the pages residing outside the system cache 22 are usually mapped to another physical memory, such as the persistent memory 24 or possibly another volatile memory module (not shown), because these pages are not mapped to the active storage, i.e., the system cache 22, these pages sometimes are described as being outside the physical memory. When a software task executing in the OS 16 or a component of the OS 16 requests a page that is mapped to a certain range in the virtual address space but is not currently mapped to the system cache 22, the MMU 30 may generate an appropriate interrupt so as to cause the requested page to be transferred to the system cache 22, thereby causing the requesting task or component of the OS 16 to temporarily suspend or at least delay further execution. Further, in some situations, the software task requests data that is not yet mapped in the virtual address space at all. For example, the application 12 may request a file stored in the persistent memory 24 using file and/or page access functions 31 provided by the OS 16, for example. When the OS 16 in turn causes the data in the specified file to be transferred to the system cache 22, the execution of the application 12 slows down.

With continued reference to FIG. 1, the computing environment 10 may include a network interface card 32 via which the computing environment 10 may be coupled to a communication network such as the Internet, for example. A user may interact with the computing environment 10 via one or several input devices 34 that include one or more of a pointing device (e.g., a mouse), a keyboard, a touchpad, a touchscreen, a voice input device, etc. The computing environment 10 may provide information to the user via one or several output devices 36 that include one or more of a monitor, a touchscreen, etc. A software UI module 38 may operate as an application running in the OS 16 or, in an alternative embodiment, as a component of the OS 16. In operation, the UI module 38 may facilitate interaction between a user and the computing environment 10.

In some embodiments, the application 12 is a resource-intensive task such as an interactive map application that renders maps, satellite imagery, terrain data, etc. on an output device 26, provides an interactive user interface to allow a user to zoom in on a desired location, pan to a desired location, select various types of data on the map or the satellite image, etc. In one such embodiment, the application 12 provides two-dimensional and three-dimensional representations of geographic regions. A user may view a two-dimensional satellite image of a certain location and dynamically switch to a three-dimensional view of the location. At the time when the application 12 transitions from a two-dimensional rendering to a three-dimensional rendering, the application 12 at least sometimes requests additional resources such as bitmap images, modeling data, etc. Further, in some cases, the application 12 invokes additional sets of functions, such as rendering functions for three-dimensional graphics, stored in a corresponding dynamically linked library (DLL), for example.

To reduce the start-up latency of the application 12 and, in some scenarios, reduce the latency due to transitioning between different modes of operation of the application 12 (e.g., from two-dimensional rendering to three-dimensional rendering), the prefetching application 14 causes some or all of binary data 40 to be transferred to the system cache 22 before the application 12 begins to execute. The prefetching application 14 may be a wrapper (e.g., a “launch stub”) application, a thread executing in the process space of the application 12, an API, etc., and may be invoked in response to a user command or upon detecting a certain event, as discussed in more detail below. In various scenarios, the binary data 40 is transferred to the system cache 22 from one or more of the persistent memory 24, a volatile memory unit having a lower access speed than the system cache 22, a remote host coupled to the computing environment 10 via a network and the network interface card 32, or another storage medium internal or external to the computing environment 10. The binary data 40 may correspond to one or more files, each of which may be stored in the system 22 and, in some cases, the persistent memory 24, as one or more pages of fixed size.

Depending on the embodiment, the binary data 40 include software instructions (“code”) 40-1, resource data (e.g., images) 40-2, configuration data (e.g., cookies, user preferences) 40-3, etc. The code 40-1 may be included in one or several DLLs or other objects utilized by the application 12. Further, the code 40-1 may include all or some of the instructions of the application 12. The instructions may be executable by a physical machine, such as a CPU, or a virtual machine, such as a Java Virtual Machine (JVM). In some embodiments, the code of the application 12 and/or the prefetching application 14 is stored in the persistent memory 24, and the binary data 40-1 corresponds to at least a portion of the executable file of the application 12. Typically, the binary data 40 is used only by the application 12 and not used by other tasks running in the computing environment 12. However, in some cases, the binary data 40 may also include shared code, e.g., a DLL used by more than one software application, or other shared resources.

In an embodiment, the prefetching application 14 identifies the binary data to be prefetched using a file list 42 transferred to the system cache 12 when the prefetching application 14 is launched. The file list 42 identifies the files which the application 12 utilizes during execution and, in an embodiment, also indicates the order in which the application 12 attempts to access these files. In an embodiment, the file list 42 includes a “trace” of the executable 12 generated during a certain run of the executable 12 to determine which files, and in what order, the application 12 accesses. As discussed in more detail below, the prefetching application 14 in some embodiments operates in a pipelined mode, in which the prefetching application 14 transfers a portion of the binary data 40 to the system cache 22 after the application 12 has been launched but before the application 12 requires the portion of the binary data 40 which the prefetching application 14 is currently transferring. Further, the prefetching application 14 in some scenarios may partially complete the transfer of binary data 40 to the system cache 22 before the application 12 launches, and continue to transfer the remaining binary data 40 in the pipelined mode after the application 12 launches.

Now referring to FIG. 2, a computing environment 50 is generally similar to the computing environment 10 depicted in FIG. 1. In particular, the computing environment 50 includes several hardware components such as a CPU 52, an MMU 54, a network interface card 56, one or several input devices 58, one or several output devices 60, a system cache 62, and a persistent memory 64 that are similar to identical to the corresponding components used in the computing environment 10. The computing environment 50 also includes an OS 66 that includes file and/or page access functions 68 that may be similar to the OS 16 and the functions 31, respectively. The OS 66 may interact with, or include, a UI application 69 that provides user interface functions to software tasks executing in the computing environment 50.

A browser application 70 operates in the computing environment 50 and may include communication stack functionality (e.g., HTTP(S), TCP, IP), web page parsing and rendering functionality, bitmap image rendering functionality, etc. A plugin 72 extends the functionality of the browser application 70. In an example embodiment, the plugin 72 includes one or several functions that provide two- and/or three-dimensional map viewing and map browsing capability similar to the example application 12 discussed with reference to FIG. 1. The plugin 72 may be implemented in a platform-independent programming language such as Java™, for example. In an embodiment, the code of the browser application 70 and the plugin 72 is stored in the persistent memory 64.

In operation, the browser application 70 receives a web page 76 from a remote host 78. The web page 76 may include text, images, audio and video content, instructions in a markup language such as HTML that describe how the content and various controls are presented on a user interface, computer instructions in a scripting language such as Javascript to enable further user interaction, etc. In an embodiment, the web page 76 also invokes the functionality of the plugin 72. For example, the web page 76 may include content that can be rendered by the plugin 72 but cannot be rendered by a browser application that does not include the plugin 72. As another example, the web page 76 may include controls such as radio buttons that invoke some of the functions of the plugin 72 when activated. In some embodiments, some or all of the functionality of the plugin 72 is accessible via an API (or APIs) included in the web page 76 or referenced and loaded by the web page 76.

To reduce the start-up latency of the plugin 72, a prefetching component 74 automatically transfers binary data 80, which the plugin 72 uses during execution, from the persistent memory 64 to the system cache 62. The prefetching component 74 alternatively or additionally may transfer binary data from a remote server to the system 62 for use by the plugin 72 during execution. Similar to the binary data 40 discussed with reference to FIG. 1, the binary data 80 may include code (e.g., the code of the plugin 72), resource data, configuration data, etc. In some embodiments, the prefetching component 74 is implemented as an API pre-installed in the computing environment 50 as a part of the plugin 72 and invoked by the corresponding API call in the web page 76. In another embodiment, the prefetching component 74 is a script (e.g., a set of Javascript instructions) referenced by the web page 76 and retrieved by the browser application 70 upon receiving the web page 76. In another embodiment, a prefetching application (not shown) that includes the prefetching component 74 may run in the computing environment 50 to prefetch binary data for the plugin 72. The prefetching application may be an executable similar to the prefetching application 14 discussed above that executes as a background task, for example. Depending on the embodiment, the prefetching application may be invoked in response to any suitable event or any suitable set of conditions (e.g., in response to a command embedded in the web page 76).

As discussed in more detail below, in various embodiments, the prefetching component 74 is referenced in the web page 76 at different locations so as to invoke the prefetching component 74 at different stages of processing the web page 76. For example, according to one embodiment, the prefetching component 74 is retrieved and invoked prior to the browser application 70 parsing the main portion (i.e., “body”) of the web page 76. To this end, a script loader may retrieve the script referenced in the header portion of the web page 76 and begin executing the script before the web page 76 has been fully parsed. On the other hand, in another embodiment, the content in the body of the web page 76 references and invokes the prefetching component 74 prior to invoking one or more functions of the plugin 72. In this case, the browser application 70 parses the body of the web page 76 at least partially prior to activating the prefetching component 74.

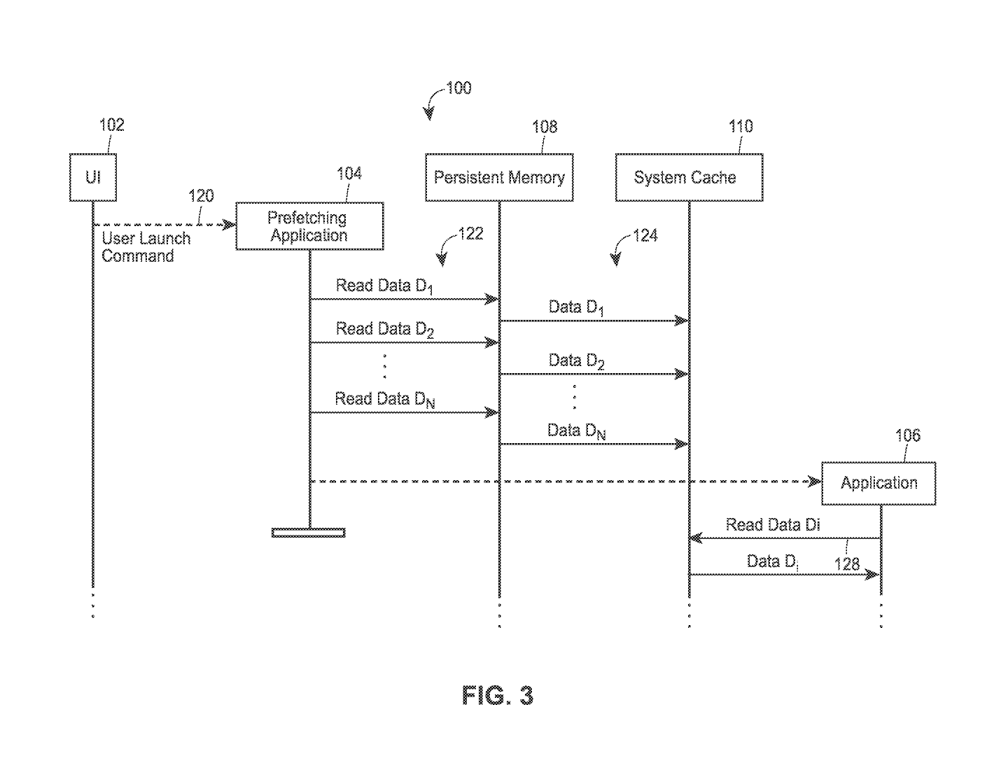

To further illustrate the techniques of the present disclosure, several example prewarming scenarios that include exchanges of data between components in a computing environment are discussed with reference to FIGS. 3-5. The computing environment may be similar to the computing environment 10 or 50, for example. In these illustrations, timelines for several components are depicted as vertical bars, solid arrows indicate messages, events, remote procedure calls (RPCs), commands issued by components, etc., and dashed arrows indicate events or commands that cause instances of software components to be created. For ease of illustration, propagation delays are not shown in FIGS. 3-5, and thus arrows are drawn horizontally (rather than diagonally).

Referring to FIG. 3, an example method 100 for prefetching binary data is implemented by a user interface 102, a prefetching application 104, and an application 106, and further involves a persistent memory 108 and a system cache 110 that operates as an active memory. The method 100 can be implemented in the computing environment 10 depicted in FIG. 1 or another environment in which the application 106 runs as an executable. According to the method 100, the prefetching application 104 is launched in response to a user command. For example, during installation, a control such as an icon that identifies the application 104 but actually refers to the prefetching application 104 may be added to the user's desktop. A user who wishes to launch the application 106 activates an icon via a graphical user interface or enters a command via a text-only interface to launch the application 106. In response, the prefetching application 104 is launched to prefetch binary data, and the application 106, depending on the embodiment, is launched after a predetermined period of time (e.g., two seconds), after the prefetching application 104 reports that a certain percentage (e.g., 50%, 75%, 100%) of the binary data used by the software application 104 has been prefetched, or in response to another suitable trigger event.

In an embodiment, the UI 102 generates an event 120 that causes the prefetching application 104 to be launched. Once launched, the prefetching application 104 transmits a series of memory transfer (or simply “read”) requests 122 (e.g., read request D₁, read request D₂, . . . read request D_{N}) to the persistent memory 108 to prefetch binary data D₁, D₂, . . . D_{N} for use by the application 106. Each read request 122 maps a respective file to a virtual memory that includes the system cache 110 and “touches” the file, i.e., reads the first byte of each memory page of the file, so as to cause the file to be transferred to the system cache 110, according to an embodiment. An operating system in which the method 100 is implemented may provide an API or a set of APIs to transfer the specified file to the system cache 110. For example, in the Windows OS, the prefetching application 104 may open a file to obtain a file handle file_handle and call the API CreateFileMapping and supply the file_handle and the flags PAGE_READONLY|SEC_IMAGE as parameters so as to cause the file data to be mapped to the system cache 110. In general, any suitable APIs or functions available in the corresponding OS may be used to transfer data to an active memory.

In the embodiment of FIG. 3, data is transferred from the persistent memory 108 to the system cache 110 in a series of read responses 124 for the respective binary data D₁, D₂, . . . D_{N}. The prefetching application 104 then causes the application 106 to be launched. For example, the application 106 may be stored in a persistent memory (such as the persistent memory 108) as a binary file having an extension that identifies the binary file as an executable, and the prefetching application may be an OS shell script that simply refers to the binary file as a command. As further illustrated in FIG. 3, the application 106 during start-up efficiently obtains data from the system cache 110 via a read request 128. For example, the application 106 may request that a certain file be opened and loaded into memory, and an MMU (not shown in FIG. 3) or another component may determine that the file is already available in the system cache 110 and quickly “unblock” the function call. Further, when the application 106 requests a particular portion of the file, the data is efficiently provided to the application 106 from the system cache 110, thereby reducing the start-up latency of the application 106.

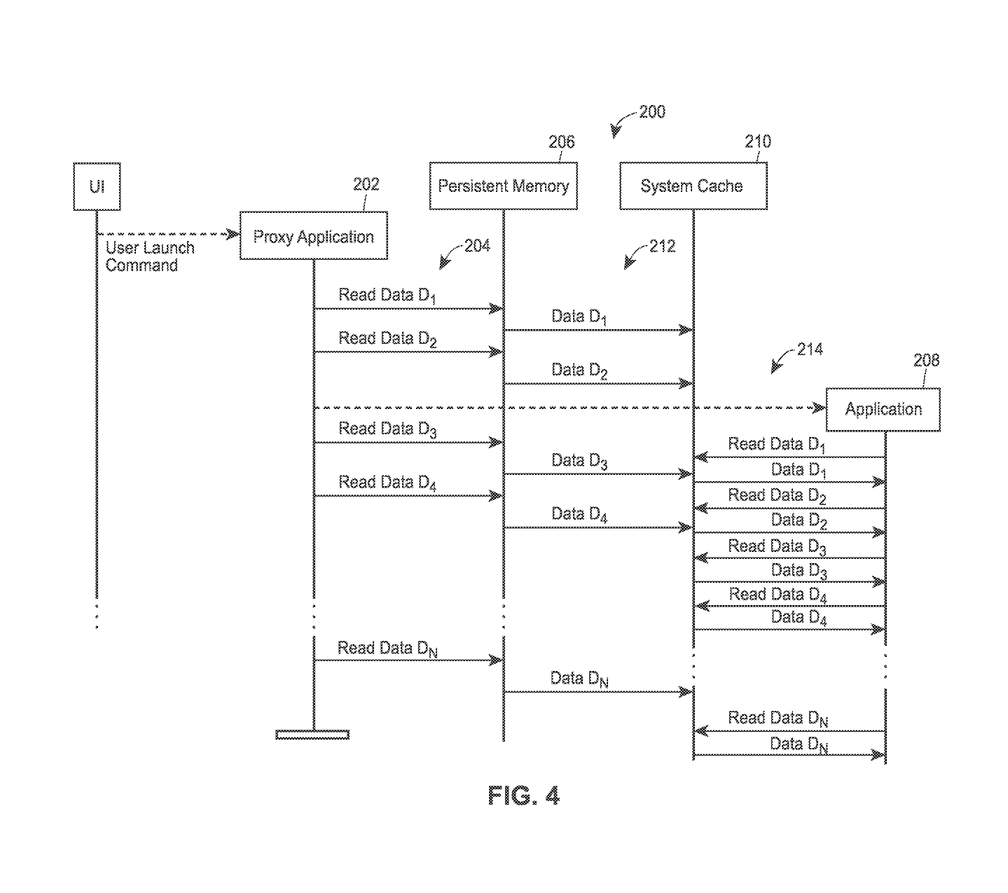

Now referring to FIG. 4, an example method 200 for prefetching binary data also can be implemented in the computing environment 10, for example. Similar to the prefetching application 104, a prefetching application 202 transmits a series of read requests 204 to a persistent memory 206 to prefetch binary data D₁, D₂, . . . D_{N} for use by an application 208, and the requested binary data is transferred to a system cache 210 in a series of read responses 212. However, the prefetching application 202 causes the application 208 to launch before all of the requested binary data is transferred to the system cache 210. For example, the binary data D₁ and D₂ t is transferred to the system cache 210 in response to the corresponding read requests prior to the application 208 being launched. The application 208 may request the binary data D₁ and D₂ upon start-up and efficiently retrieve the data D₁ and D₂ from the system cache 210 via data request and response messages 214. Meanwhile, the prefetching application 202 may transmit read requests for binary data D₃ and D₄ to the persistent memory 206 to trigger corresponding read responses so as to cause the binary data D₃ and D₄ to be transferred to the system cache 210 before the application 208 reaches an execution stage at which the binary data D₃ and D₄ is required. In a similar manner, the prefetching application 104 may continue to prefetch binary data for use by the application 208 concurrently with the execution of the application 208.

The prefetching application 202 may determine the order in which the binary data D₁, D₂, . . . D_{N} is prefetched according to a configuration or trace file list (such as the file list 42 discussed with reference to FIG. 1). In an embodiment, the files corresponding to the binary data D₁, D₂, . . . D_{N} are listed in the order in which the application 208 accesses the binary data D₁, D₂, . . . D_{N} during a representative run. In another embodiment, a user manually defines the order in which the files corresponding to the binary data D₁, D₂, . . . D_{N} are listed.

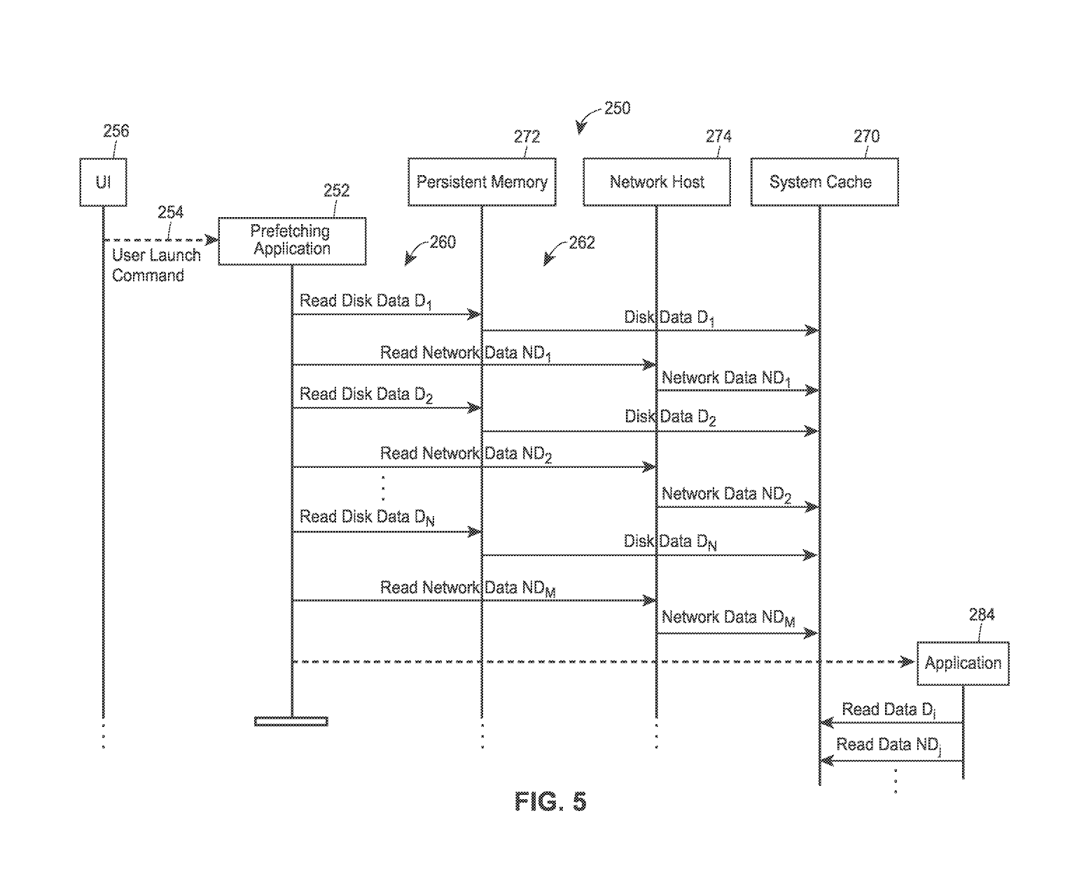

FIG. 5 illustrates an example method 250 that can be implemented in the computing environment 10 (or a similar environment) to prewarm a software application by transferring binary data for the software application to a system cache when at least some of the binary data is disposed on a remote host. In response to an event 254 received from a UI component 256, a prefetching application 252 generates a series of read disk data requests 260 (e.g., read request D₁, read request D₂, . . . read request D_{N}) and a series of read network data requests 262 (e.g., read network data request D₁, read request network data D₂, . . . read network data request D_{M}) to cause binary data to be transferred to a system cache 270 from a persistent memory 272 and a remote host 274, respectively. In some embodiments, the prefetching application 252 issues the series of requests 260 and 262 concurrently. Referring back to FIG. 1, for example, the network interface card 32 may operate independently of the CPU 20, i.e., using a separate processing unit, a separate clock, a separate memory buffer, etc. Accordingly, the prefetching application 252 may efficiently transmit the series of requests 262 via the network card without significantly affecting the concurrent requests 260.

As further illustrated in FIG. 5, the prefetching application 252 may launch an application 284 after the binary data has been transferred to the system cache 270. In another embodiment, the prefetching application 252 launches an application 284 upon expiration of a timer. Similar to the method of FIG. 3, binary data is efficiently provided to the application 284 from the system cache 270 upon start-up and during subsequent operation.

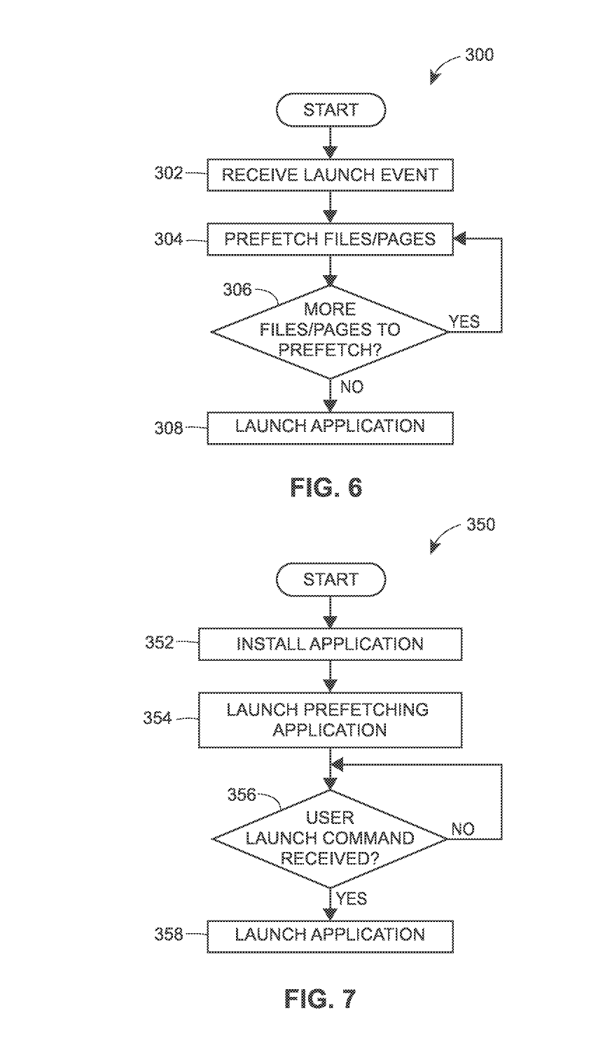

Next, several example methods for prefetching binary data for an application or a browser plugin are discussed with reference to flow diagrams illustrated in FIGS. 6-10. In general, some or all of these methods can be implemented using any suitable combination of software, firmware, and hardware components in a computing environment such as the computing environment 10 or 50, for example. When implemented in software, the methods of FIGS. 6-10 can be implemented as instructions in any suitable programming, scripting, or mark-up language. Further, in some embodiments, a combination of computer languages, mark-up languages, scripts, etc. may be used.

Referring first to FIG. 6, a method 300 for prefetching binary data may be implemented by one or more components in the computing environment 10, for example. By way of a more specific example, the method 300 may be implemented in the prefetching application 14. However, a method similar to the method 300 also may be implemented in the computing environment 50, for example, in which binary data is prefetched for use by a browser plugin rather than an application. The method 300 begins at block 302 when a launch event, such as a request to launch a software application, is received from a user interface or a script, for example. At block 304, pages of data corresponding to one or more files are prefetched. In at least some of the embodiments, the pages of data are transferred to a system cache implemented in a RAM module provided on the CPU, a separate RAM module, or in another suitable manner. Further, in an embodiment, the files are loaded and touched so as to ensure the corresponding data is mapped to active memory and merely to a non-active (e.g., non-physical) portion of a virtual memory. If it is determined at block 306 that additional files, or pages in the file currently being processed, are still available, the control is returned to block 304 for additional prefetching.

At block 308, the application that uses the data prefetched at block 304 begins execution and utilizes the prefetched binary data during at least some of the stages of execution. In an embodiment, a prefetching application (e.g., the prefetching application 14) launches the application indirectly by generating an event that indicates that the binary data for the application has been prefetched, and that the application can now be launched. In another embodiment, the prefetching application issues a direct command to launch the application.

FIG. 7 is a flow diagram of an example method 350 for prefetching data for a software application following an installation of the software application in a computing environment. Similar to the method 300, the method 350 may be implemented in the computing environment 10, although it is also possible to apply the techniques in the method 350 to a browser plugin and the corresponding prefetching component. The method 350 begins at block 352, in which a software application is installed. Because a user is likely to start the installed software application shortly after installation, a proxy application is launched at block 354 to prefetch binary data for use by the software application. For example, the software application may be provided with an installer application that installs the software application at block 352 and automatically launches the software application at block 354. The control then passes to block 356 until a command to launch the application is received at block 358 from the user or an automated entity such as a script. At block 358, the application is launched.

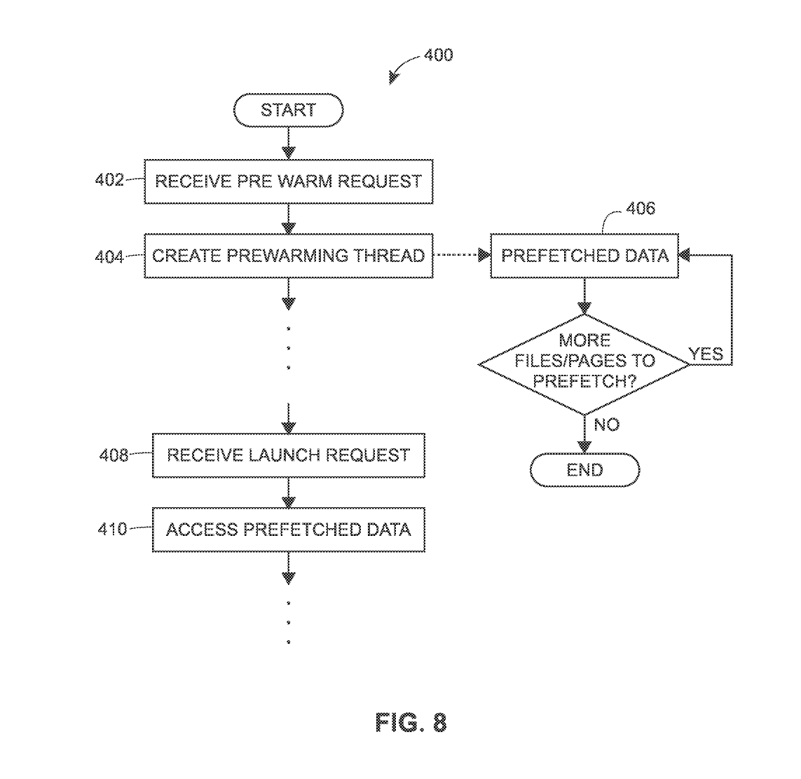

Referring to FIG. 8, an example method 400 for pipelined prefetching of binary data begins at block 402, in which a request to prewarm a software component such as an application or a browser plugin is received. Depending on the embodiment, the request is received from a user interface, a web page received from a remote host, an application or a script, etc. At block 404, a prewarming task is created as a separate thread or process. The prewarming task then prefetches binary data at block 406 at the same time as the main task of the method 400 continues to execute. At block 408, a request to launch the software component is received, and the software component accesses the prefetched binary data at block 410. The prewarming task continues to execute or is terminated when block 410 is reached, depending on the embodiment and/or the amount of binary data that needs to be prefetched for the software component.

In an embodiment, the method 400 is implemented in a browser application that receives a web page and begins to execute a script included in the web page. The script may in turn launch a background software task as a thread within the browser application or as a separate process in the corresponding operating system to prewarm a plugin which is conditionally or unconditionally activated on the web page. The background software task may then load, as binary data, the plugin itself (i.e., the code of the plugin executable in the corresponding computing environment) and/or other data associated with the plugin to make the binary data available in the system cache.

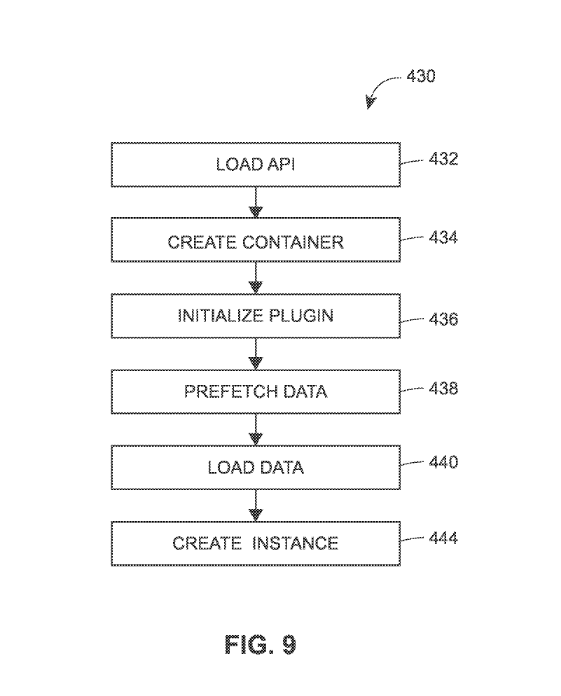

FIG. 9 is a flow diagram of an example method 430 for processing a web page received from a remote host that invokes the functionality of a plugin either unconditionally or conditionally, e.g., in response to the user activating a certain control provided on the web page. The method 430 may be implemented in the browser application 70 in the computing environment 50, for example, to process the web page 76 that interacts with the plugin 72. As discussed above, a web page is generally made up of text, images, directives written in a mark-up language such as HTML, scripts, etc. In an embodiment, the web page 76 is scripted so as to cause the browser application 70 to execute the method 430 when processing the web page 76.

At block 432, an API that provides programmatic access to the plugin 72 is loaded. For example, an instruction included in the web page 76 may reference the location at which the API is stored using a Universal Resource Locator (URL). In an embodiment, the plugin 72 allows the browser application 70 to display an interactive map that includes satellite imagery, zoom on a specified location, pan across the displayed imagery, etc. Because the interactive map provided by the plugin 72 may occupy a portion of a window, or a “container,” in which the web page 76 is displayed, an appropriate container for the plugin 72 is created at block 434. For example, if the web page 76 is developed using HTML, the container may be specified using an appropriate div tag.

Next, at block 436, the plugin 72 is initialized. Depending on the embodiment, initial parameters may be supplied, callback functions such as error handlers may be installed, etc. At block 438, binary data for use by the plugin 72 may be automatically prefetched from a local persistent storage device, a local volatile memory, one or more network hosts, etc. To this end, the web page 76 may include a prefetching component such as script or a function call that prefetches binary data according to one of the techniques discussed above. After the binary data has been prefetched, web page data is loaded at block 440. At this point, the web browser application may parse the portion of the web page that references various resources on the server that supplied the web page and/or other servers according to the corresponding URLs. For example, in an implementation that uses HTML, the portion of the web page processed at block 440 is demarcated by a pair of body tags.

At block 444, an instance of an object that uses the plugin initialized at block 436 is created. For example, in the embodiment according to which the plugin provides an interactive map and satellite imagery, a new interactive map may be rendered within the container created at block 434 using the functionality of the plugin initialized at block 436. At this time, one or more plugin functions may request a large amount of binary data including, for example, bitmap images, vector data, text resources, user profile data, etc. Because at least some of the binary data has been prefetched at block 438, the plugin functions have a lower start-up latency.

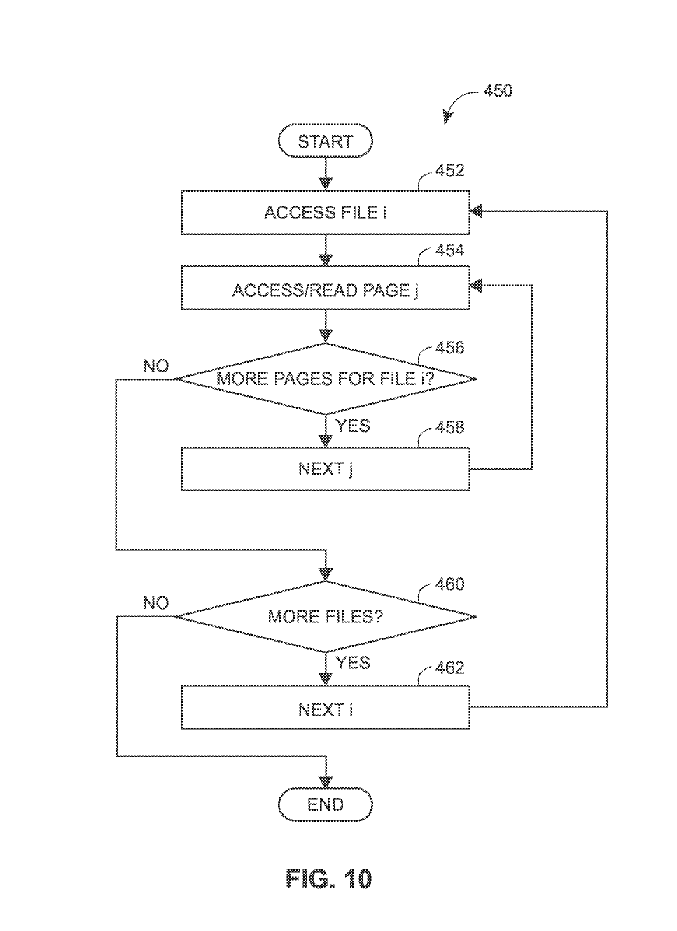

Now referring to FIG. 10, a prefetching software component such as the prefetching application 14 or the prefetching component 74 implement a method 450 to prefetch binary data corresponding to one or several files, according to an embodiment. The prefetching software component may use a list stored in a configuration file to determine the names and the locations of files to be prefetched and, in some cases, the order in which the files are to be prefetched. At block 452, a file i is accessed. Depending on the embodiment, the file i is accessed from a local storage device such as a hard disk or a remote storage device such as a network host. A page j of the file i is accessed or read in a manner that results in the page j being mapped to a system cache, at block 454. If it is determined, at block 456, that more pages are available for the file i, the index j is updated, and the flow returns to block 454. In an embodiment, blocks 454 and 456 are implemented as one or several calls to functions provided by the corresponding operating system (e.g., “read file” and “touch file”). Otherwise, if no additional pages are available, the flow continues to block 460 to determine whether additional files are available. For example, i may be an integer index used to sequentially access consecutive files stored in a list or array. If it is determined that additional files are available, index i is updated, and the flow returns to block 452. Otherwise, the method 450 ends.

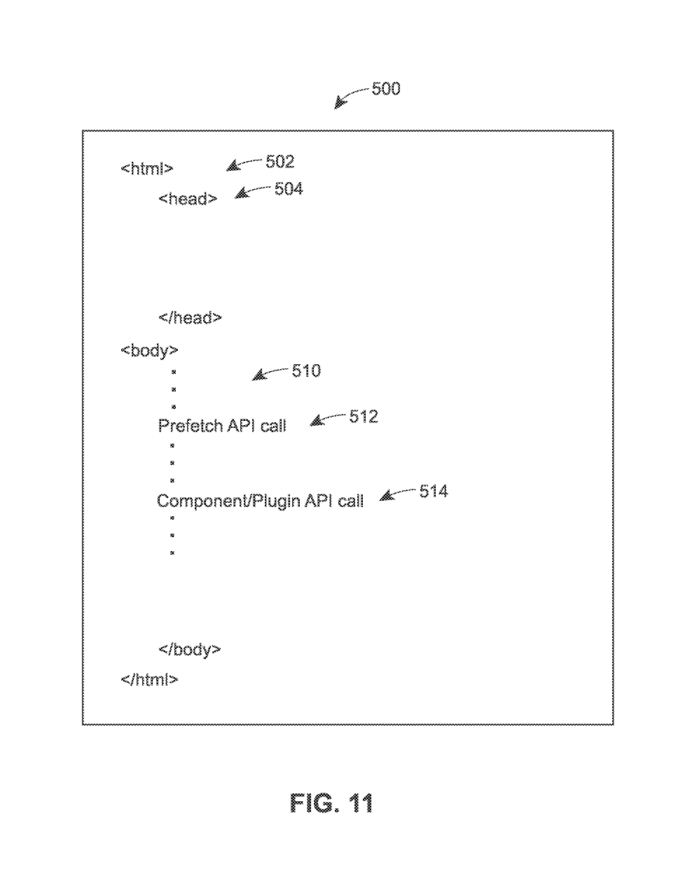

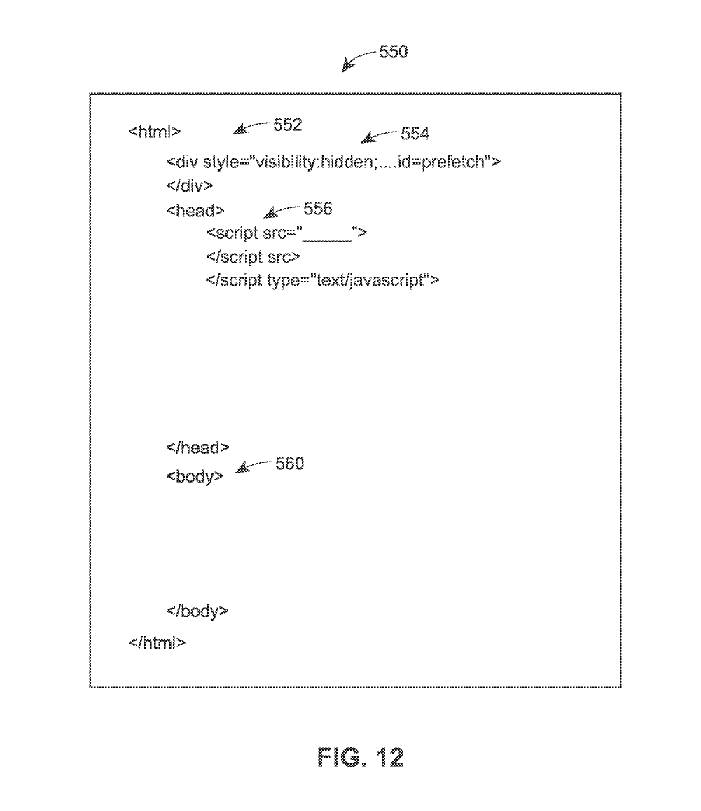

Next, FIGS. 11 and 12 illustrate several example implementations of a web page which a network host may generate, and a browser application may process, so as to cause binary data used by a plugin to be prefetched before the functionality of the plugin is invoked. In an embodiment, the browser application 70 of FIG. 2 receives a web page consistent with the format illustrated in FIG. 11 or FIG. 12 from the remote host 78, parses the web page, executes the script, and launches the functionality of the plugin 72 in response to a function call included in the web page or a user command.

In general, a web page consistent with the format of FIG. 11 or FIG. 12 (or a similar format) may enable a user to peruse and interact some content while binary data is prefetched for rendering other content using a plugin. According to some scenarios, a developer of the web page may reasonably expect that the user will invoke the plugin if the user is interacting with the web content in a particular manner or retrieves particular web content. For example, the developer may decide that if the user is viewing a two-dimensional map provided on the web page, the user is likely to also activate a plugin that provides a three-dimensional of a geographic area. Accordingly, the developer may format and script the web page so as to prewarm the plugin by prefetching binary data for the plugin. Further, the developer may decide to prewarm the plugin unconditionally or according to a predictive model in response to one or more signals (e.g., user data stored in a cookie, the type of data user views on the two-dimensional map, etc.).

Referring to FIG. 11, an example web page 500 is formatted using HTML. The web page 500 includes content 502 delimited by a pair of html tags. Within the pair of html tags, a header section 504 is delimited by a pair of head tags, and a body section 504 is delimited by a pair of body tags. In an embodiment, the web page 500 includes a prefetch API call 510 in the body section 504. The prefetch API call 510 may operate as a prefetching component provided, for example, as a set of instructions in Javascript. The set of instructions may be included as a part of the content of the web page 500 (e.g., within the header section 504). Alternatively, the set of instructions may be provided by a remote host and referenced within the header section 504, so that the browser application processing the web page 500 may retrieve the set of instructions when parsing the header section 504. As yet another alternative, the set of instructions may be pre-stored in the computing environment in which the web page 500 is being processed. In some of these embodiments, a script loader (e.g., a Javascript loader) automatically retrieves the script from the specified location upon parsing the reference to the script in the web page 500. Referring back to FIG. 2, the set of instructions may be provided as the prefetching component 74 in the computing environment 50.

According to an embodiment, the prefetch API call 510 creates an invisible (or “hidden”) container in which a prewarming instance of the plugin is created, which may be considered to be a “dummy” version of the plugin. The prewarming instance of the plugin may be invoked so as to prewarm the plugin rather than invoke the functionality of the plugin. In an embodiment, the prefetch API call 510 is automatically executed so that when the web page 500 is loaded and the appropriate event is generated, the plugin is at least partially prewarmed. In other words, by the time the browser application notifies the user (or various automated scripts and tasks) that the web page 500 is fully loaded, the prefetch API call 510 has been invoked and at least some of the binary data used by the plugin has been transferred to the system cache.

With continued reference to FIG. 11, the web page 500 further includes a plugin API call 514 in the body section 504. In an embodiment, the plugin API call 514 is unconditional. In another embodiment, the plugin API call 514 is triggered by an event that corresponds to a user activating a certain control such as a radio button or a pull-down list, for example. In this case, the user may activate the plugin only after the web page 500 has been fully loaded.

The plugin API call 514 may cause the functionality of the plugin to be invoked within an appropriate container. For example, an interactive map may be displayed within a certain region of the window of the browser application. In an embodiment, the prefetch API call 510 continues to execute within an invisible portion of the browser application window when the user activates the plugin.

FIG. 12 is a diagram of another example web page 550 that is formatted using HTML and that invokes a prefetching script that causes binary data for a plugin to be transferred to a system cache prior to the functionality of the plugin being invoked. Similar to the web page 500, the web page 550 has a content section 552 that in turn includes a header section 556 and a body section 560. In the illustrated embodiment, the web page 550 includes a container description 554 that specifies an invisible container. In particular, the container description 554 indicates that an invisible container with a particular identifier should be created. The container description 554 is included after the html tag but before the header section 556.

The header portion 556 may include a reference to a script and specify the type of the script (e.g., Javascript) to indicate how the script should be interpreted. In an embodiment, the script automatically prefetches binary data for a plugin. In another embodiment, the script retrieves a set of instructions of a prewarming API, so that the API can be invoked in the body of the web page 550. Similar to the example implementation discussed with reference to FIG. 11, the script may include instructions that create a prewarming instance of the plugin. To accommodate the prewarming instance, the container specified in the container description 554 may be used. In particular, the script referenced in the header portion 556 may include a function call that specifies the identifier of the container described in the container description 554. It is noted that in the embodiment of FIG. 12, the plugin may be at least partially prewarmed as the body section 560 is being parsed.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for prefetching binary data through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A tangible non-transitory computer-readable medium having a web page stored thereon, wherein the web page includes content and instructions that, when interpreted by a browser application that executes on one or more processors of a client device, cause the browser application to:
display the content on the client device;
identify, at the client device, non-executable resource binary data to be accessed by a browser plugin during execution;
transfer the identified non-executable resource binary data to a system cache of the client device, wherein the binary data is used only by the browser plugin configured to operate in the browser application; and
launch the browser plugin, wherein the browser plugin accesses the non-executable resource binary data via the system cache during execution;
wherein the non-executable resource binary data is transferred to the system cache prior to launching the browser plugin.

2. The computer-readable medium of claim 1, wherein the instructions cause the browser application to launch a task to transfer the non-executable resource binary data to the system cache, wherein the task executes in parallel with the browser loading the content.

3. The computer-readable medium of claim 2, wherein the non-executable resource binary data is a first non-executable resource binary data; and wherein the task transfers second non-executable resource binary data to the system after launching the browser plugin but before the browser plugin attempts to access the second non-executable resource binary data via the system cache.

4. The computer-readable medium of claim 1, wherein the instructions further cause the browser application to create a hidden container to accommodate a prewarming component that transfers the non-executable resource binary data to the system cache.

5. The computer-readable medium of claim 4, wherein the instructions cause the browser application to create the hidden container using a div tag having a display attribute set to hidden.

6. The computer-readable medium of claim 4, wherein a subset of the instructions that causes the browser application to create the hidden container is included before a header section of the web page.

7. The computer-readable medium of claim 1, wherein the instructions include a call to an application programming interface (API) included within a body section of the web page.

8. The computer-readable medium of claim 1, wherein the instructions include a call to an API included in a script referenced in a header section of the web page.

9. (canceled)

10. The computer-readable medium of claim 1, wherein the system cache is implemented in a volatile physical memory.

11. The computer-readable medium of claim 1, wherein:
the non-executable resource binary data includes a plurality of files, and
each of the plurality of files occupies one or more pages in an address space;
wherein to transfer the non-executable resource binary data to the system cache, the instructions cause the browser application to read at least a first byte of each of the one or more pages for each of the plurality of files.

12. The computer-readable medium of claim 1, wherein:
the instructions further cause the browser application to display a user control on the client device; and
the instructions launch the browser plugin in response to a user actuating the displayed user control.

13. The computer-readable medium of claim 1, wherein the instructions further cause the browser application to initialize the browser plugin before the non-executable resource binary data is transferred to the system cache.

14. A tangible non-transitory computer-readable medium having instructions stored thereon that, when executed by one or more processors, cause the one or more processors to:
receive, at a client device, an indication that a browser plugin is to be launched within a browser application, wherein the browser application executes on the one or more processors at the client device;
in response to receiving the indication, identify, at the client device, non-executable resource binary data which the browser plugin uses during execution; and
prefetch, at the client device, the non-executable resource binary data before the browser plugin is launched, wherein the non-executable resource binary data is available in a system cache when the browser plugin is launched.

15. The computer-readable medium of claim 14, wherein:
the non-executable resource binary data occupies a plurality of pages in an address space; and
the instructions to prefetch binary data cause the browser application to load and touch each of the plurality of pages.

16. The computer-readable medium of claim 14, wherein the instructions to receive the indication, identify the non-executable resource binary data, and prefetch the non-executable resource binary data are executed in response to an API call invoked by the browser application.

17. The computer-readable medium of claim 16, wherein the API call is included in a script in a web page received from a remote host.

18. The computer-readable medium of claim 14, wherein the instructions further cause the one or more processors to launch the browser plugin.

19. (canceled)

20. (canceled)

21. The computer-readable medium of claim 14, wherein the instructions cause the browser application to generate an invisible container to accommodate a prewarming component that transfers the non-executable resource binary data to the system cache.

22. A method for efficiently launching a browser plugin in a browser application, wherein the browser application operates on a web page having content and a plurality of instructions, the method comprising:
receiving, by one or more processors at a client device, an indication that the browser plugin is to be launched on the one or more processors at the client device;
in response to receiving the indication, identifying non-executable resource binary data which the browser plugin uses during execution, by the one or more processors at the client device; and
prefetching, by the one or more processors at the client device, the non-executable resource binary data before the browser plugin is launched, wherein the non-executable resource binary data is available in a system cache when the browser plugin is launched.

23. The method of claim 22, wherein the indication that the browser plugin is to be activated is received in response to an API call, wherein the API call corresponds to one of the plurality of instructions in the web page.

24. The method of claim 23, wherein the API call is included in a header section of the web page, wherein the header section is delimited by a corresponding tag.

25. The method of claim 23, wherein the API call is included in a body section of the web page, wherein the body section is delimited by a corresponding tag.

26. The method of claim 22, further comprising:
detecting that the browser application has finished loading the content of the web page; and
activating the browser plugin in response to detecting that the browser application has finished loading the content.

27. The method of claim 22, wherein the non-executable resource binary data occupies a plurality of pages in an address space; and
wherein prefetching the non-executable resource binary data includes touching each of the plurality of pages.

28. The method of claim 22, wherein prefetching the non-executable resource binary data includes launching a task that executes in parallel with the browser application processing the content of the web page.
